(19) United States
(12) Patent Application Publication
(10) Pub. No.: US 2013/0266264 A1
(43) Pub. Date: Oct. 10, 2013

(54) OPTICAL MODULE AND METHOD FOR MAKING THE SAME

(71) Applicant: NEC Corporation, Tokyo (JP)

(72) Inventor: Isao Tomita, Tokyo (JP)

(21) Appl. No.: 13/991,473

(22) PCT Filed: Dec. 16, 2011
(86) PCT No.: PCT/JP2011/079969

§ 371 Date: Jun. 4, 2013

(30) Foreign Application Priority Data
Dec. 21, 2010 (JP) 2010-284140

(51) Int. Cl. G02B 6/42

(52) U.S. Cl. CPC G02B 6/4292
USPC 385/52; 29/428

(57) ABSTRACT

An optical module includes a module substrate; a first optical component disposed on the module substrate; and a second optical component disposed apart from the first optical component in a direction perpendicular to the module substrate, wherein the first optical component includes a first optical main part facing and optically connecting to the second optical component, and a first peripheral part located in the periphery of the first optical main part without facing the second optical component; the first peripheral part includes a first fiducial mark as a reference for a disposed position of the first optical component; the second optical component includes a second fiducial mark as a reference for a disposed position of the second optical component; and the first fiducial mark and the second fiducial mark are aligned on the same straight line when they are projected on to a plane parallel to the module substrate.

### TECHNICAL FIELD

The present invention relates to optical modules and methods for making the same, in particular, to an optical module and a method for making the same to be used for optical communications.

### BACKGROUND ART

As a key device for optical network systems, there is an optical module into which main components necessary for transmitting and receiving optical signals are integrated. With respect to the optical module to be used for a receiver in optical communications, for example, an optical fiber, a photodiode (PD), and a trans-impedance amplifier (TIA) are mounted in a ceramic package. The photodiode photoelectrically converts optical signals transmitted through an optical fiber connecting medium, and the trans-impedance amplifier converts the impedance of current signals of the output of the photodiode and then amplifies and outputs the converted signals as voltage signals.

Meanwhile, because of the rapid increasing in communication traffic of recent years, it has been required to expand the transmission capacity of the optical network system. With the optical network system speeding up and increasing in capacity, it has been also required to miniaturize and speed up the optical module used for the optical communication. For speeding up, a technology is known that makes the inside of the optical module multichannel. For example, optical modules have been developed which realize a transmission rate of 40 Giga bits per second (Gbs) by using four channels each of which has a transmission rate of 10 Gbs, and realize a transmission rate of 100 Gbs by using four channels each of which has a transmission rate of 25 Gbs.

In order to miniaturize and speed up the optical module, it is necessary to couple optical elements in the optical module optically with high efficiency, and therefore, high-accuracy mounting has been required. An example of the optical modules in which optical connection is performed with a high degree of accuracy is described in patent literature 1.

The optical module described in patent literature 1 is configured so as to mount an optical element array on a substrate and to optically connect on the substrate the optical element array to an optical waveguide array including an optical path changing mirror structure in optical waveguide channels which are located at the outer end of the array. In order to make the optical module, the optical waveguide array is made to approach the optical element array with the optical element array driven by applying a bias. And then, as optical signals output through the optical path changing mirror are monitored from the optical waveguide channels located at each end of the optical waveguide array channels, optical axis alignment is performed between the optical waveguide array channels and the optical element array. After that, the optical waveguide array is fixed on the substrate at the position where the output of the optical signal becomes an intended value. It is said that such configuration enables the optical waveguide array to optically connect to the optical element array with high efficiency and stably.

In patent literature 2, an optical module is described in which at least one device marker is formed on an optical semiconductor device to be utilized for an alignment when implementing it and at least one mounting marker is formed on a mounting substrate to be utilized for an alignment when implementing it. In this related optical module, the device marker is formed in parallel to a semiconductor waveguide and moreover so that at least the end parts reach the end surface bumping against the mounting substrate. And the mounting marker is formed in parallel to an optical waveguide and moreover so that at least the end parts reach the end surface bumping against the optical semiconductor device, and furthermore is formed so that its end position may be aligned with that of the device marker. It is said that a space between the end surface of the optical waveguide and the end surface of the semiconductor waveguide becomes zero by such configuration, and therefore coupling efficiency can be stabilized for all products regardless of the accuracy of cleaving.

Patent Literature 1: Japanese Patent Application Laid-Open Publication No. 2009-288614 (paragraphs [0015] and [0020], and FIG. 1)

Patent Literature 2: Japanese Patent Application Laid-Open Publication No. 2002-062447 (paragraphs [0011] and [0026], and FIG. 1)

### DISCLOSURE OF INVENTION

### Problem to be Solved by the Invention

Since the optical module described in above-mentioned patent literature 1 uses an active alignment in which optical axis alignment is performed between the optical waveguide array channels and the optical element array as monitoring optical signals, it is possible to obtain alignment accuracy with a high degree of accuracy. However, there is a problem that a time for mounting increases if the number of channels in the optical module is increased in order to speed up the optical module.

Meanwhile, the difficulty level in mounting an optical module has been increasing due to multi-channelizing an optical module and the like, for example, that alignment accuracy with a high degree of accuracy is required about not only positional accuracy but also angular directions. However, since the optical module described in patent literature 2 uses a passive mounting method in which the optical module is provided with alignment markers for mounting in advance, there has been a problem that it is difficult to enhance the mounting accuracy. Moreover, a need has arisen to arrange optical components in three dimensions inside the optical module due to miniaturizing an optical module and the like. However, there has been a problem that mounted positions are misaligned because it becomes difficult to detect alignment markers due to optical components overlapping to each other in the vertical direction.

As mentioned above, in the related optical modules, there have been problems that it is difficult to enhance the mounting accuracy and a time for mounting increases with optical modules speeding up and miniaturized.

The object of the present invention is to provide an optical module and a method for making the same which solve the problems mentioned above that it is difficult to enhance the mounting accuracy and a time for mounting increases with optical modules speeding up and miniaturized.

### Means for Solving a Problem

An optical module according to an exemplary aspect of the present invention includes a module substrate; a first optical component disposed on the module substrate; and a second optical component disposed apart from the first optical component in a direction perpendicular to the module substrate, wherein the first optical component includes a first optical main part facing and optically connecting to the second optical component, and a first peripheral part located in the periphery of the first optical main part without facing the second optical component; the first peripheral part includes a first fiducial mark as a reference for a disposed position of the first optical component; the second optical component includes a second fiducial mark as a reference for a disposed position of the second optical component; and the first fiducial mark and the second fiducial mark are aligned on the same straight line when they are projected on to a plane parallel to the module substrate.

A method for making an optical module according to an exemplary aspect of the invention includes the steps of forming a first optical component including a first optical main part and a first peripheral part located in the periphery of the first optical main part; forming a first fiducial mark as a reference for a disposed position of the first optical component on the first peripheral part; forming a second optical component optically connected to the first optical main part; forming a second fiducial mark as a reference for a disposed position of the second optical component on the second optical component; mounting the first optical component and the second optical component on a module substrate; disposing the first optical component and the second optical component apart from each other in a direction perpendicular to the module substrate so that the first optical main part may face the second optical component, and the first peripheral part may not face the second optical component; and performing an alignment so that the first fiducial mark and the second fiducial mark may be aligned on the same straight line when they are projected on to a plane parallel to the module substrate, and fixing them.

### Effect of the Invention

According to the optical module and the method for making the same of the present invention, it is possible to enhance the mounting accuracy, which is required with optical modules speeding up and miniaturized, and it is possible to suppress the increase in a time for mounting.

### BRIEF DESCRIPTION OF THE DRAWINGS

FIG. 1A is a plan view showing a configuration of an optical module in accordance with the first exemplary embodiment of the present invention.

FIG. 1B is a side view showing a configuration of an optical module in accordance with the first exemplary embodiment of the present invention.

FIG. 2 is a plan view showing another configuration of an optical module in accordance with the first exemplary embodiment of the present invention.

FIG. 3 is a plan view showing still another configuration of an optical module in accordance with the first exemplary embodiment of the present invention.

FIG. 4A is a plan view showing a configuration of an optical receiver module in accordance with the second exemplary embodiment of the present invention.

FIG. 4B is a side view showing a configuration of an optical receiver module in accordance with the second exemplary embodiment of the present invention.

FIG. 5A is a plan view showing a part of a configuration of an optical receiver module in accordance with the second exemplary embodiment of the present invention.

FIG. 5B is a side view showing a part of a configuration of an optical receiver module in accordance with the second exemplary embodiment of the present invention.

FIG. 6A is a plan view to illustrate a method for making an optical receiver module in accordance with the second exemplary embodiment of the present invention.

FIG. 6B is a side view to illustrate a method for making an optical receiver module in accordance with the second exemplary embodiment of the present invention.

FIG. 7A is a plan view to illustrate a method for making an optical receiver module in accordance with the second exemplary embodiment of the present invention.

FIG. 7B is a side view to illustrate a method for making an optical receiver module in accordance with the second exemplary embodiment of the present invention.

### DESCRIPTION OF EMBODIMENTS

The exemplary embodiments of the present invention will be described with reference to drawings below.

### The First Exemplary Embodiment

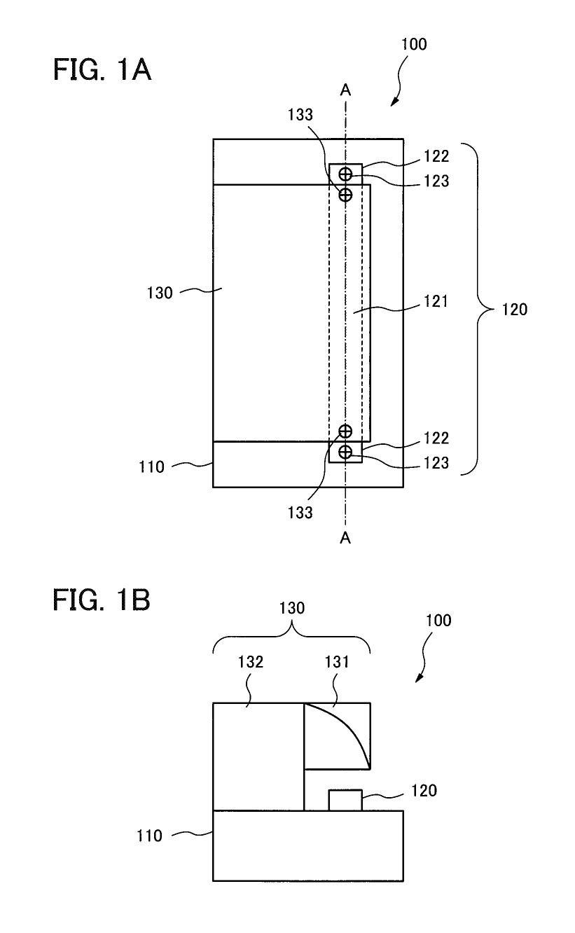

FIGS. 1A and 1B are diagrams showing a configuration of an optical module in accordance with the first exemplary embodiment of the present invention, FIG. 1A is a plan view and FIG. 1B is a side view. The optical module 100 according to an aspect of the present invention includes a module substrate 110, a first optical component 120 disposed on the module substrate 110, and a second optical component 130 disposed apart from the first optical component 120 in a direction perpendicular to the module substrate 110.

The first optical component 120 includes a first optical main part 121 facing and optically connecting to the second optical component 130, and a first peripheral part 122 located in the periphery of the first optical main part 121 without facing the second optical component 130. The first peripheral part 122 is provided with a first fiducial mark 123 as a reference for a disposed position of the first optical component 120. On the other hand, the second optical component 130 is provided with a second fiducial mark 133 as a reference for a disposed position of the second optical component 130. And the first fiducial mark 123 and the second fiducial mark 133 are aligned on the straight line (A-A) when they are projected on to a plane parallel to the module substrate.

In this way, in the optical module 100 according to the present exemplary embodiment, it is configured that the first fiducial mark 123 is disposed on the first peripheral part 122 which does not face the second optical component 130. Consequently, even though the first optical component 120 and the second optical component 130 are disposed in a direction perpendicular to the module substrate, and there exists an overlapped area when they are projected on to a plane parallel to the module substrate, the first fiducial mark 123 and the second fiducial mark 133 do not overlap at all. Accordingly, it becomes possible to align the positions of the first optical component 120 and the second optical component 130 so that the first fiducial mark 123 and the second fiducial mark 133 may be disposed on the same straight line. As mentioned above, according to the present exemplary embodiment, it is possible to enhance the mounting accuracy, which responds to speeding up and miniaturizing of optical modules, and it is possible to suppress the increase in a time for mounting because the active alignment is unnecessary.

It is possible to use a configuration in which the first optical main part 121 includes a light receiving element, for example. At this time, it is also acceptable to use a light receiving element array composed of a plurality of light receiving elements which responds to multi-channelizing. It is not limited to this, it is also acceptable for the first optical main part 121 to include a light emitting element such as a semiconductor laser. And it is also acceptable for the first optical main part 121 to use a semiconductor laser array composed of a plurality of semiconductor lasers elements, which responds to multi-channelizing.

It is possible to use a configuration in which the second optical component 130 includes a reflecting mirror, for example. Any one of a focusing mirror with a curved reflecting surface and a configuration of combination of a lens and a planar mirror can be used as the reflecting mirror. As shown in FIG. 1B, the second optical component 130 can adopt a configuration in which a reflecting mirror 131 is connected to a planar lightwave circuit (PLC) substrate 132.

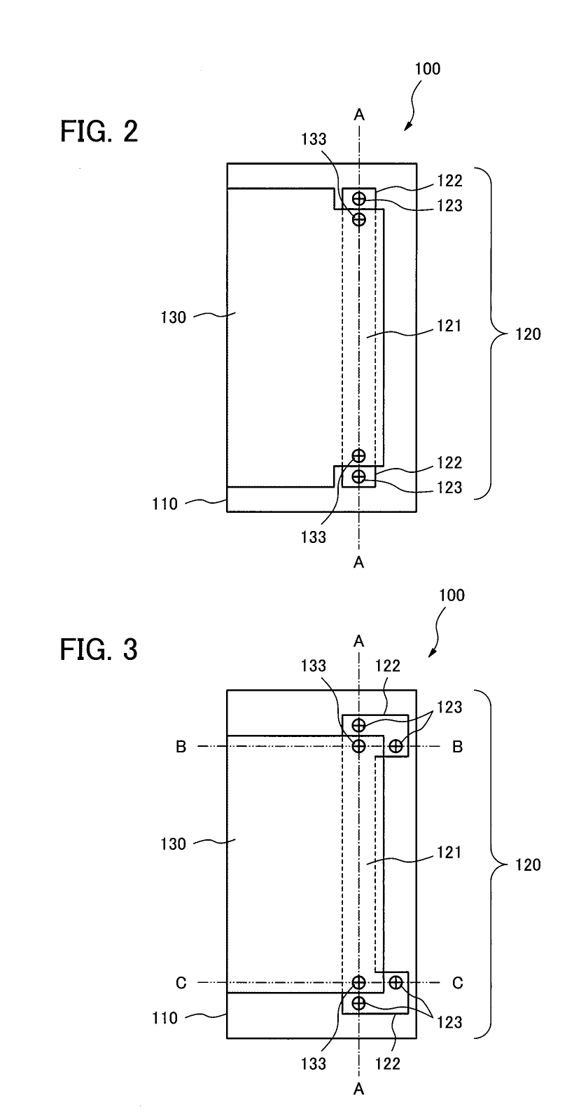

In FIG. 1A, a case is illustrated where the first peripheral part 122 composing the first optical component 120 is disposed beyond the area occupied by the second optical component 130. However, it is not limited to this, as shown in FIG. 2, a configuration is also acceptable in which the second optical component 130 has a portion cut away in the area for the second optical component 130 to face the first peripheral part 122. In this case, since it is possible to make the external dimensions of the first optical component 120 and those of the second optical component 130 the same, further miniaturizing of the optical module 100 can be realized.

FIG. 1A illustrates a case where the first optical component 120 is provided with the first fiducial mark 123 one by one on each first peripheral part 122, and the first fiducial mark 123 and the second fiducial mark 133 align on the same straight line (A-A) at two areas. However, it is not limited to this, as shown in FIG. 3, a configuration is also acceptable in which two pieces of the first fiducial marks 123 are disposed on each first peripheral part 122, and the first fiducial mark 123 and the second fiducial mark 133 align on a first straight line (B-B) and a second straight line (C-C) in addition to the straight line (A-A). In this case, since the alignment is performed at four parts in total, that is, at two parts per each of two directions on the plane parallel to the module substrate 110, it becomes possible to further enhance the mounting accuracy.

Next, a method for making the optical module 100 according to the present exemplary embodiment will be described. Hereinafter, a case will be described as an example in which a light receiving element array is used as the first optical component 120 and the reflecting mirror 131 connected to the planar lightwave circuit (PLC) substrate 132 shown in FIG. 1B is used as the second optical component 130.

First, a light receiving element array, which includes a plurality of light receiving elements composing the first optical main part, and semiconductor substrate regions composing the first peripheral part, which correspond to both end parts of the light receiving elements, is formed on a semiconductor substrate. On each semiconductor substrate region, cruciform alignment markers, for example, are formed as the first fiducial mark by means of etching process and the like. And a reflecting mirror which is optically connected to the plurality of light receiving elements is formed, and on the reflecting mirror, cruciform alignment markers, for example, are also formed as the second fiducial mark.

Next, the light receiving element array and the reflecting mirror are mounted into a ceramic package as the module substrate. In the present exemplary embodiment, as shown in FIG. 1B, the reflecting mirror 131 is mounted into the ceramic package interposing the planar lightwave circuit (PLC) substrate 132. At this time, the light receiving element array and the reflecting mirror are disposed apart from each other in a direction perpendicular to the bottom face of the ceramic package so that the plurality of light receiving elements may face the reflecting mirror, and the semiconductor substrate regions may not face the reflecting mirror. That is to say, it is possible to miniaturize the optical module by disposing the light receiving element array and the reflecting mirror in three dimensions in the ceramic package. And then, the alignment is performed so that the respective alignment markers of the light receiving element array and the reflecting mirror may be aligned on the same straight line when they are projected on to a plane parallel to the bottom face of the ceramic package, and then, they are fixed. Through the above processes, the optical module 100 has been completed.

As described above, according to the method for making the optical module of the present exemplary embodiment, the reflecting mirror is not formed at the position facing the semiconductor substrate regions on which the alignment markers of the light receiving element array are formed. Consequently, the alignment markers of the light receiving element array and those of the reflecting mirror do not overlap with each other, and thus, it is possible to enhance the mounting accuracy in either configuration where the optical module has been miniaturized.

### The Second Exemplary Embodiment

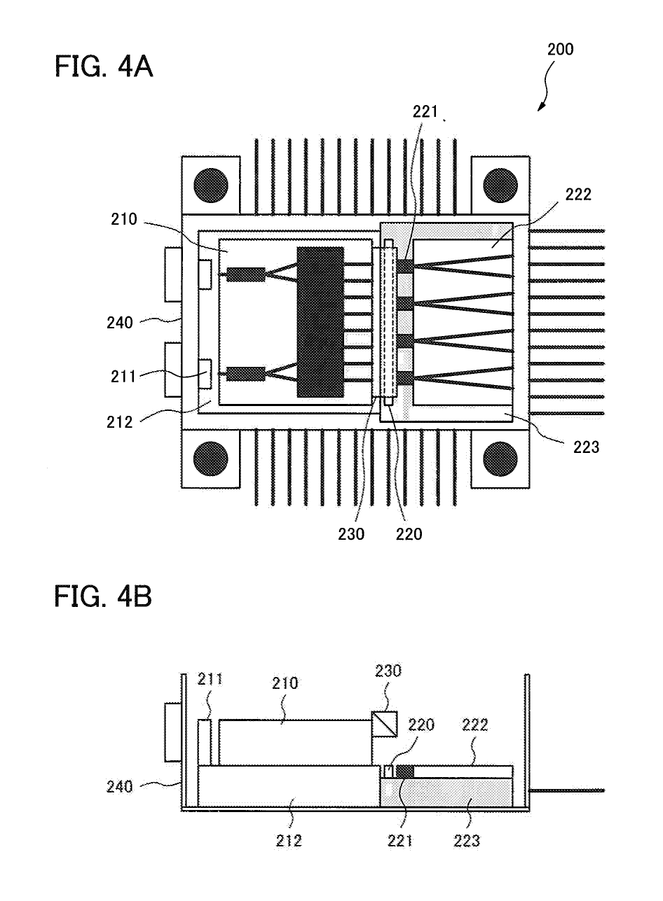

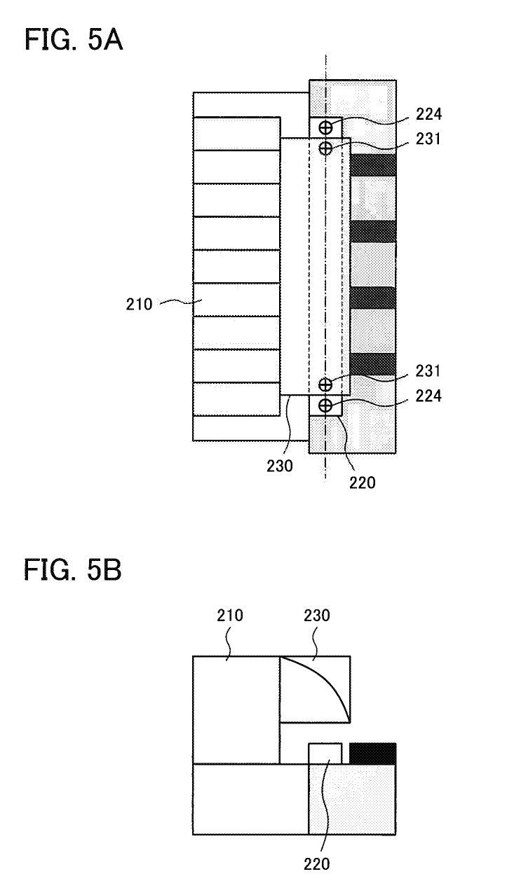

Next, the second exemplary embodiment of the present invention will be described. FIGS. 4A and 4B are diagrams illustrating a configuration of a receiving light module 200 according to the present exemplary embodiment, FIG. 4A is a plan view, and FIG. 4B is a side view. FIGS. 5A and 5B are magnified views illustrating a part of configuration of the light receiving module 200 according to the present exemplary embodiment, FIG. 5A is a plan view, and FIG. 5B is a side view. In the present exemplary embodiment, a case will be described as an example in which the optical module is applied to a light receiving module 200 used for a digital coherent receiver corresponding to a DP-QPSK method. Here, the DP-QPSK method represents a dual polarization quadrature phase shift keying method.

The light receiving module 200 includes a planar lightwave circuit (PLC) substrate 210, a photodiode (PD) 220, and a focusing mirror 230 which changes the optical path of the light emitted from the planar lightwave circuit (PLC) substrate 210 and couples the light to the photodiode (PD) 220. The planar lightwave circuit (PLC) substrate 210 includes a polarization beam splitter (PBS) and a beam splitter (BS), and functions as a coherent mixer. The planar lightwave circuit (PLC) substrate 210 is mounted on a device carrier 212 together with lens 211 which couples the light from an optical fiber to the planar lightwave circuit (PLC) substrate 210. The photodiode (PD) 220 is mounted on a substrate carrier 223 together with a transimpedance amplifier (TIA) 221 and a wiring substrate 222. These members are packed in a ceramic package 240 and compose the light receiving module 200.

In the light receiving module 200 corresponding to the DP-QPSK method, four kinds of signal, each of which is composed of two pairs of signals, that is, output signals for eight ports in total are obtained by separating optical signals into a TE polarization component and a TM polarization component and making them interfere with local oscillation light with delay. By receiving these signals using the differential-type transimpedance amplifier (TIA) 221, modulated optical signals transmitted through optical fibers are demodulated. In this way, the light receiving module 200 needs eight photodiode (PD) elements and four differential-type transimpedance amplifiers (TIA) 221s for the signal demodulation in order to receive the optical signals from eight ports of the planar lightwave circuit (PLC) substrate 210. Therefore, a photodiode (PD) array including eight photodiode (PD) elements is used as the photodiode (PD) 220.

Here, if the distance between the photodiode (PD) 220 and each of the transimpedance amplifiers (TIAs) 221s becomes longer, high-frequency characteristics deteriorate. Accordingly, in order to obtain good electrical characteristics, it is desirable to mount the photodiode (PD) 220 and the transimpedance amplifier (TIA) 221 as close to each other as possible. Therefore, the configuration is adopted in which the photodiode (PD) 220 and the transimpedance amplifier (TIA) 221 are disposed adjacently and the photodiode (PD) 220 receives the output light which is bent to it and is output from the planar lightwave circuit (PLC) substrate 210. As a result, it is possible to realize speeding up and miniaturizing of the light receiving module 200.

In order to suppress the increase in a time for mounting, it is necessary to mount the focusing mirror 230 using as a reference only positional accuracy of alignment markers which are placed on the photodiode (PD) 220 and the focusing mirror 230 without the active alignment.

On the other hand, in related passive mounting methods, alignment markers are placed on a photodiode (PD) and a mirror respectively, and a mounting process is performed so that the respective markers may overlap with each other. However, in this case, a problem arises that it is impossible to check the overlap of the markers because the markers on the photodiode (PD) overlap with the shade of the mirror. Even though using a material, as a material of the mirror, which has a large transmittance to the wavelength of a laser beam used for checking markers, it is difficult to perform a mounting with high accuracy because an optical path is subtly changed due to its refraction.

Therefore, in the present exemplary embodiment, as shown in FIG. 5A, a first alignment marker 224 is placed on the periphery of the photodiode (PD) 220 without facing the focusing mirror 230. As a result, it is possible to solve the problem that the overlap of the alignment markers cannot be checked because the alignment markers hide behind the shade of the focusing mirror 230 when mounting the focusing mirror 230 having a second alignment marker 231. It becomes possible to realize high accuracy mounting by performing the mounting so that the first alignment markers 224s and the second alignment markers 231s may be aligned on the same straight line.

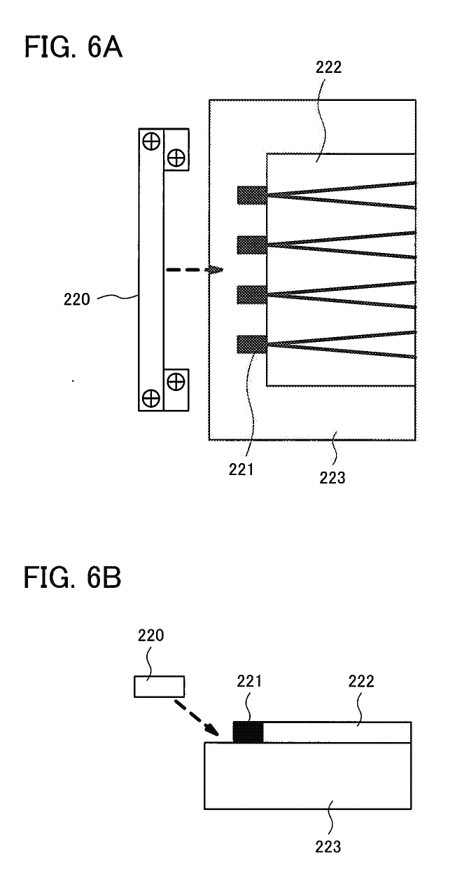

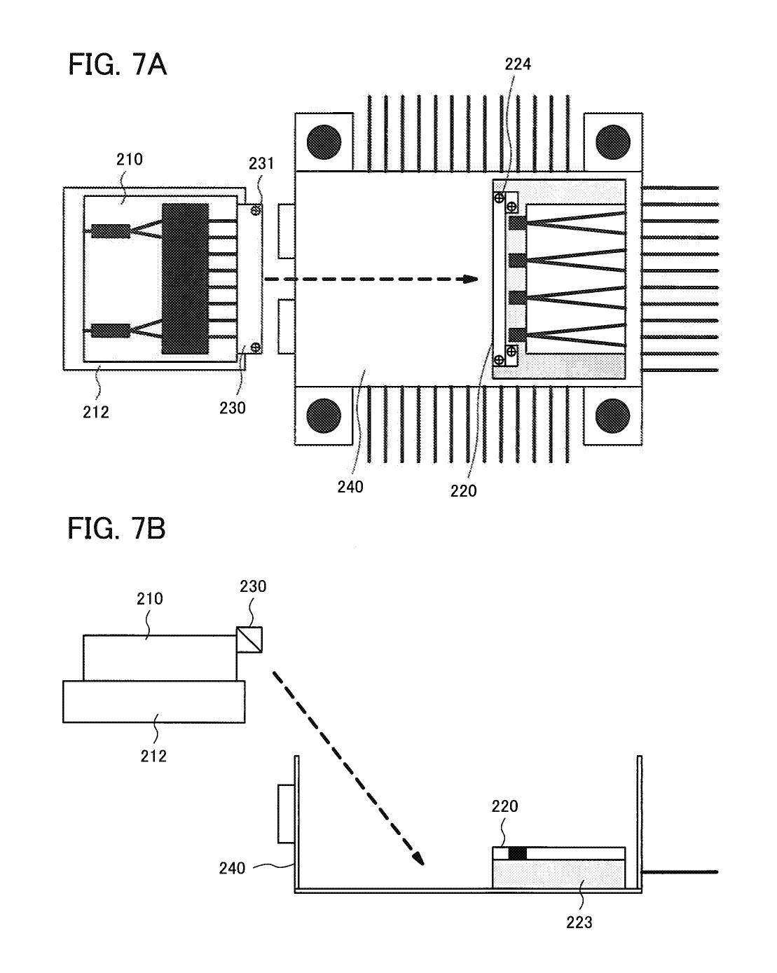

Next, a method for making the light receiving module 200 according to the present exemplary embodiment will be described. FIGS. 6A, 6B, 7A, and 7B are diagrams to illustrate the method for making the light receiving module 200 according to the present exemplary embodiment, and FIGS. 6A and 7A are plan views, and FIGS. 6B and 7B are side views.

As shown in FIGS. 6A and 6B, first, the wiring substrate 222 including electric wiring for high-frequency signals is mounted on the substrate carrier 223, and the transimpedance amplifier (TIA) 221 is mounted on the substrate carrier 223 using the wiring pattern of the wiring substrate 222 as a fiducial. Subsequently, the photodiode (PD) 220 including eight photodiode elements is mounted so as to be aligned with the transimpedance amplifier (TIA) 221.

Next, as shown in FIGS. 7A and 7B, the focusing mirror 230 is mounted at the emission edge of the planar lightwave circuit (PLC) substrate 210 carried on the device carrier 212. Subsequently, the substrate carrier 223 carrying the photodiode (PD) 220 and the like is mounted into the ceramic package 240. Finally, the device carrier 212 carrying the focusing mirror 230 and the like is mounted into the ceramic package 240. At this time, the eight photodiode elements and the focusing mirror 230 are disposed apart from each other in a direction perpendicular to the bottom face of the ceramic package 240 so that the eight photodiode elements may face the focusing mirror 230, and the periphery of the photodiode (PD) 220 on which a photodiode element is not formed may not face the focusing mirror 230. And then, the alignment is performed by using the first alignment marker 224 placed on the periphery of the photodiode (PD) 220 on which a photodiode element is not formed, and the second alignment marker 231 placed on the focusing mirror 230. That is to say, the alignment is performed so that the first alignment marker 224 and the second alignment marker 231 may be aligned on the same straight line when they are projected on to a plane parallel to the bottom face of the ceramic package 240, and then, they are fixed.

As described above, according to the method for making the optical module of the present exemplary embodiment, the focusing mirror 230 is not disposed at the position facing the periphery of the photodiode (PD) 220 on which a photodiode element is not formed. Consequently, the alignment markers of the photodiode (PD) 220 and those of the focusing mirror 230 do not overlap with each other, and thus, it is possible to enhance the mounting accuracy in either configuration where the light receiving module has been speeded up and miniaturized.

The present invention is not limited to the above-mentioned exemplary embodiments and can be variously modified within the scope of the invention described in the claims. It goes without saying that these modifications are also included in the scope of the present invention.

This application is based upon and claims the benefit of priority from Japanese Patent Application No. 2010-284140, filed on Dec. 21, 2010, the disclosure of which is incorporated herein in its entirety by reference.

### DESCRIPTION OF THE CODES

100 optical module
110 module substrate
120 first optical component
121 first optical main part
122 first peripheral part
123 first fiducial mark
130 second optical component
131 reflecting mirror
132 planar lightwave circuit (PLC) substrate
133 second fiducial mark
200 light receiving module
210 planar lightwave circuit (PLC) substrate
211 lens
212 device carrier
220 photodiode (PD)
221 transimpedance amplifier (TIA)
222 wiring substrate
223 substrate carrier
224 first alignment marker
230 focusing mirror
231 second alignment marker
240 ceramic package

1. An optical module, comprising:
a module substrate;
a first optical component disposed on the module substrate; and
a second optical component disposed apart from the first optical component in a direction perpendicular to the module substrate,
wherein the first optical component comprises a first optical main part facing and optically connecting to the second optical component, and a first peripheral part located in the periphery of the first optical main part without facing the second optical component;
the first peripheral part comprises a first fiducial mark as a reference for a disposed position of the first optical component;
the second optical component comprises a second fiducial mark as a reference for a disposed position of the second optical component; and
the first fiducial mark and the second fiducial mark are aligned on the same straight line when they are projected on to a plane parallel to the module substrate.

2. The optical module according to claim 1,
wherein the first optical main part comprises a plurality of optical elements.

3. The optical module according to claim 1,
wherein the first peripheral part comprises a plurality of the first fiducial marks; and
the first fiducial mark and the second fiducial mark are aligned on a plurality of the same straight lines respectively when they are projected on to a plane parallel to the module substrate.

4. The optical module according to claim 1,
wherein the first optical component comprises a light receiving element, and the second optical component comprises a reflecting mirror.

5. The optical module according to claim 1,
wherein the first optical component comprises a light emitting element, and the second optical component comprises a reflecting mirror.

6. A method for making an optical module, comprising the steps of:
forming a first optical component comprising a first optical main part and a first peripheral part located in the periphery of the first optical main part;
forming a first fiducial mark as a reference for a disposed position of the first optical component on the first peripheral part;
forming a second optical component optically connected to the first optical main part;
forming a second fiducial mark as a reference for a disposed position of the second optical component on the second optical component;
mounting the first optical component and the second optical component on a module substrate;
disposing the first optical component and the second optical component apart from each other in a direction perpendicular to the module substrate so that the first optical main part may face the second optical component, and the first peripheral part may not face the second optical component; and
performing an alignment so that the first fiducial mark and the second fiducial mark may be aligned on the same straight line when they are projected on to a plane parallel to the module substrate, and fixing them.

7. The optical module according to claim 2,
wherein the first peripheral part comprises a plurality of the first fiducial marks; and
the first fiducial mark and the second fiducial mark are aligned on a plurality of the same straight lines respectively when they are projected on to a plane parallel to the module substrate.

8. The optical module according to claim 2,
wherein the first optical component comprises a light receiving element, and the second optical component comprises a reflecting mirror.

9. The optical module according to claim 3,
wherein the first optical component comprises a light receiving element, and the second optical component comprises a reflecting mirror.

10. The optical module according to claim 2,
wherein the first optical component comprises a light emitting element, and the second optical component comprises a reflecting mirror.

11. The optical module according to claim 3,
wherein the first optical component comprises a light emitting element, and the second optical component comprises a reflecting mirror.
